(19) United States
(12) Patent Application Publication
(10) Pub. No.: US 2012/0039409 A1
(43) Pub. Date: Feb. 16, 2012

(54) POSITIONING REFERENCE SIGNALS

(75) Inventors: Branislav Popovic, Kista (SE); Fredrik Berggren, Kista (SE)

(73) Assignee: Huawei Technologies Co., Ltd., Shenzhen (CN)

(21) Appl. No.: 13/283,062

(22) Filed: Oct. 27, 2011

Related U.S. Application Data
(63) Continuation of application No. PCT/CN2009/071507, filed on Apr. 27, 2009.

(51) Int. Cl. H04L 27/28

(52) U.S. Cl. 375/260

(57) ABSTRACT

An improved generation and use of Positioning Reference Signals (PRS) generates PRS to be used in a wireless Orthogonal Frequency Division Multiplexing (OFDM) communication system. A time-frequency pattern of Resource Elements (REs) is determined and used for transmitting the PRS, wherein the time-frequency pattern includes at least two OFDM symbols. Each one of the at least two OFDM symbols is assigned a value to each one of a number of the REs being within that OFDM symbol. The values being assigned to the number of REs correspond to elements in a modulation sequence having a length being equal to the number of REs, and are to be used for modulating OFDM subcarriers corresponding to the REs within that OFDM symbol.

### CROSS-REFERENCE TO RELATED APPLICATIONS

This application is a continuation of International Application No. PCT/CN2009/071507, filed on Apr. 27, 2009, which is hereby incorporated by reference in its entirety.

### FIELD OF THE APPLICATION

The present application relates to communication technology.

The present application relates to a method for generating a Positioning Reference Signal to be used in a wireless Orthogonal Frequency Division Multiplexing (OFDM) communication system.

The present application also relates to a method of a receiving node for detecting a timing value in such a communication system.

The present application also relates to a method for transmitting the PRS, to a computer program and to a computer program product implementing the methods of the application.

The present application also relates to an entity arranged for generating a PRS to be used in such a communication system, and to a transmitting node.

The present application also relates to a receiving node arranged for detecting a timing value to be used for determining its position in such a communication system.

### RELATED ART AND BACKGROUND OF THE APPLICATION

A requirement in many wireless communication systems, for instance cellular systems utilizing Orthogonal Frequency Division Multiplexing (OFDM), such as the Long Term Evolution (LTE) system, is that the system is capable of accurately determining the location of a receiving node, such as a mobile station or a user equipment (UE). Usually the location of the receiving node is determined by the serving cell, on the basis of measurements being performed at the receiving node. Alternatively, the receiving node can based on the measurement results determine its location itself.

The measurements at the receiving node reflect the distance of the receiving node from at least two neighboring cells, whose coordinates are known by the serving cell. Typically, the number of neighboring cells used is between 3 and 5.

The usual measure used for determining the receiving cell position is a Time Difference of Arrival (TDOA) between a positioning reference signal (PRS) being transmitted from the serving cell and PRSs being transmitted by other cells, i.e. the neighboring cells, being selected for distance measurements. The signals from different cells will arrive at the receiving node at different times due to the different distances between the receiving node and the cells, respectively, which is used for determining the receiving node location.

The measured TDOA ^{Δt}_{^{2,1}} is usually fed back to the serving sell, which use this information to calculate the distance difference between the receiving node and the cell1, and between the receiving node and cell2 as:

Δd_{2,1}=c·Δt_{2,1}=d₂−d₁, (eq. 1)

where

c is the velocity of light,

dᵢ={square root over ((xᵢ₋ₓ₎²+(yᵢ−y)²)},

(x, y) is the unknown position of the receiving node, and

(xᵢ, yᵢ) is the position of the ith cell.

If K cells are detected by the receiving node, the equation 1 defines (K−1) non-linear equations, whose solution gives the unknown position of the receiving node (x, y).

The Time Of Arrival (TOA) of PRSs can be detected by utilizing the cross-correlation between the received signal and all the PRSs that have been indicated to the receiving node by the serving cell. The PRSs with whom the receiving node correlates the received signal should unambiguously, one-to-one, correspond to the cell IDs of the cells in the set of cells being used for the measurement.

Normally, it can be assumed that the receiving node receives information about the set of PRSs it should measure, i.e. the set of cells from which the receiving node receives a signal, as well as the relative transmit timing of these signals.

The PRSs are assumed to be transmitted in specially allocated subframes, containing either 12 or 14 OFDM symbols. These special subframes should experience low interference and could be based either on regular subframes without Physical Downlink Shared Channel (PDSCH) transmission, or on Multicast Broadcast Single Frequency Network (MBSFN) subframes.

In regular OFDM subframes, the reference signals from LTE must remain, while that is not necessary if MBSFN subframes are used, since LTE Release 8 User Equipments (UEs) will not be scheduled in such subframes. The control region, typically the first 2 OFDM symbols in the OFDM subframe, cannot be used for the PRS. If regular OFDM subframes are used, it may also be desirable to only transmit the PRS in the OFDM symbols that do not contain the LTE cell-specific Common Reference Signals (CRSs).

FIG. 1 shows a regular prior art OFDM subframe, in which there are 9 available OFDM symbols for PRS.

An important requirement for a large set of PRSs, e.g. a set of PRSs corresponding one-to-one to the cell IDs of the system, i.e. a set containing 504 PRSs for LTE, is that the aperiodic cross-correlation between any two PRSs is as small as possible, while the aperiodic auto-correlation of each PRS should have as much as possible impulse-like shape, i.e. as low as possible sidelobes.

An impulse-like shaped auto-correlation allows accurate Time Difference Of Arrival (TDOA) estimation in case of multipath propagation, i.e. it minimizes the probability of finding a false TDOA due to high sidelobes of the auto-correlation. The cross-correlation properties determine the level of interference resulting from neighboring cells when the PRS subframes from different cells are partially or fully aligned. Low cross-correlation between PRSs allows better usage of the time-frequency resources, as more cells can transmit simultaneously. Thus, fewer PRS subframes are needed when the cross-correlation is low.

Generally, the existing CRSs being used for channel estimation in a communication system utilizing OFDM, e.g. the LTE cellular system, are contained in certain OFDM symbols within a subframe of 12 or 14 OFDM symbols, with every sixth Resource Element (RE) used for transmission of energy. The RE corresponds to a sinusoid (also called a subcarrier), whose frequency is a multiple integer of the inverse of the duration of the OFDM symbol, and whose duration is equal to the duration of an OFDM symbol. Different cell-specific Reference Signals (RSs) have different frequency offsets of occupied REs, having values in the range between 0 and 5 REs, depending on the cell ID. The used CRS REs are modulated by the elements of a cell-specific QPSK pseudo-random sequence. For positioning purposes, the LTE CRSs may not provide sufficient signal-to-interference plus noise ratio.

Further, since the number of time-frequency resources for PRSs is limited in the communication system, it is difficult to generate a large number of time-frequency patterns which exhibit good cross-correlation properties, as eventually there will become a large number of “hits” between different patterns, i.e., usage of the same REs.

Also, it is important that the peak-to-average power ratio of the PRS should be as low as possible, in order to maximize the received energy from each cell involved in Observed Time Difference Of Arrival (OTDOA) measurement. If there is no data transmission in the subframes used for PRS, it might lead to that all the subcarriers in a PRS become co-phased at some instants. This undesirable effect is particularly present if all the REs of the PRS are modulated with a same value (e.g., unity).

FIG. 2 shows a prior art solution, in which a time-frequency pattern for PRSs based on a Costas Arrays of length 10 has been proposed to be used in a PRS subframe. The exact Costas Array pattern to be used will here depend on design choices for the PRS subframe. For example, the pattern used will depend on the choice between normal and extended cyclic prefix subframes, wherein the latter contains less OFDM symbols, or if MBSFN subframes are to be used. In FIG. 2, a candidate Costas Array of length 10 proposed in for use in extended cyclic prefix MBSFN subframes is shown.

The array in FIG. 2 can be mapped into resource blocks having a bandwidth corresponding to 12 subcarriers. To fill out the system bandwidth, this 12×10 block could be replicated in frequency, leaving 2 subcarriers empty per resource block Alternatively, the 10×10 array may be replicated across all resource blocks without coordination with resource block boundaries. In this case, there are no empty subcarriers.

Different cells would have different versions of a generic array shown in FIG. 2, wherein these versions are obtained by cyclically shifting the 10×10 pattern in time and frequency. The shifts are performed modulo 10 rows and modulo 10 columns. The pattern shown in FIG. 2 has the property that all cyclic time/frequency shifts of the sequence overlap in at most two symbols with a majority of the sequences overlapping in less than two symbols.

In addition, if only time shifts or frequency shifts are used, there is no overlap between patterns. Also, some pairs of patterns that are both time and frequency shifted are orthogonal. Thus, there are a total of 10×10=100 possible time/frequency shifts of the array in FIG. 2, leading to a total of 100 distinct time-frequency patterns that overlap with each other in at most two symbols.

In FIG. 3, another prior art solution of a denser time-frequency pattern is shown. In this prior art solution, different PRSs are obtained by cyclically shifting the given pattern in the frequency domain. Hence, only 6 unique PRSs can be generated. The time-frequency pattern is repeated over the whole system bandwidth.

The above described prior art solutions have a number of drawbacks, of which one is that the number of PRSs possible to generate is significantly less than the number of cell IDs in a normal communication system. If the number of PRSs is smaller than the number of cell IDs in the system, additional system planning may be needed to assure that sufficiently many unique candidate sets of PRSs can be formed in the network.

Further, these prior art solutions have high Peak to Power Average Ratios (PAPRs) for the PRSs. For the two described prior art time-frequency patterns, the PAPRs of the PRSs in a 20 MHz bandwidth are 20.9 and 23.2 dBs, respectively, which are problematic levels requiring large backoff in the power amplifiers used for transmitting the PRSs.

### SUMMARY OF THE APPLICATION

It is an object of the present application to provide a generation and use of PRSs that solve the above stated problems.

The object is achieved by the above mentioned method for generating a PRS according to the characterizing portion of claim 1, i.e. a method performing the steps of:
determining a time-frequency pattern of REs to be used for transmitting the PRS, wherein the time-frequency pattern includes at least two OFDM symbols, and
assigning, for each one of the at least two OFDM symbols, respectively, a value to each one of a number of the REs being within that OFDM symbol, wherein
the values being assigned to the number of REs correspond to elements in a modulation sequence having a length being equal to the number of REs, and are to be used for modulating OFDM subcarriers corresponding to the REs within that OFDM symbol.

The object is also achieved by the above mentioned method according to the characterizing portion of claim 18, i.e. by the receiving node performing the steps of, while utilizing knowledge of a cell ID of each one of at least three cells:
determining a time-frequency pattern of REs having been used for transmitting a received signal,
determining at least one modulation sequence having been used for modulating the OFDM subcarriers corresponding to REs of the time-frequency pattern, wherein the at least one modulation sequence has a length being equal to a number of the REs being within an OFDM symbol being part of the time-frequency pattern, and
   determining, based on the determined time-frequency pattern and the determined at least one modulation sequence, the timing value for the received signal in relation to signals from the other ones of the at least three cells.

The object is also achieved by the above mentioned entity according to the characterizing portion of claim 24, i.e. the entity comprising
determination means arranged for determining a time-frequency pattern of REs to be used for transmitting the PRS, wherein the time-frequency pattern includes at least two OFDM symbols,
assigning means arranged for assigning, for each one of the at least two OFDM symbols, respectively, a value to each one of a number of the REs being within that OFDM symbol, wherein—the values being assigned to the number of REs correspond to elements in a modulation sequence having a length being equal to the number of REs, and are to be used for modulating OFDM subcarriers corresponding to the REs within that OFDM symbol.

The object is also achieved by the above mentioned transmitting node according to the characterizing portion of claim 25, i.e. the transmitting node transmitting the PRS having been generated in an entity comprising:
determination means arranged for determining a time-frequency pattern of Resource Elements (REs) to be used for transmitting the PRS, wherein the time-frequency pattern includes at least two OFDM symbols,
assigning means arranged for assigning, for each one of the at least two OFDM symbols, respectively, a value to each one of a number of the REs being within that OFDM symbol, wherein—the values being assigned to the number of REs correspond to elements in a modulation sequence having a length being equal to the number of REs, and are to be used for modulating OFDM subcarriers corresponding to the REs within that OFDM symbol.

Thus, the entity arranged for generating the PRS can be located either within or outside the transmitting node itself. That is, the PRS can be generated in a separate entity and be stored in the transmission node, or it can be both generated and transmitted by the transmit node.

The object is also achieved by the above mentioned receiving node according to the characterizing portion of claim 26, i.e. the receiving node comprising:
determining means arranged for determining, while utilizing knowledge of a cell ID of each one of at least three cells, a time-frequency pattern of Resource Elements (REs) having been used for transmitting a received signal,
determination means arranged for determining, while utilizing the knowledge, at least one modulation sequence having been used for modulating the OFDM subcarriers corresponding to the REs of the time-frequency pattern, wherein the at least one modulation sequence has a length being equal to a number of the REs being within an OFDM symbol being part of the time-frequency pattern,
determination means arranged for determining, while utilizing the knowledge, based on the determined time-frequency pattern and the determined at least one modulation sequence, the timing value for the received signal in relation to signals from the other ones of the at least three cells.

The object is also achieved by the above mentioned method for transmitting the PRS, the computer program, and the computer program product implementing the methods of the application.

The generation of the PRS, the method for transmitting the PRS, the method for detecting a timing value, the entity being arranged for generating the PRS, the transmitting node arranged for transmitting the PRS, and the receiving node arranged for detecting the timing value according to the present application are characterized in that they define the PRS by a time-frequency pattern of REs over multiple OFDM symbols and modulation sequences being used for modulating the REs being within the time-frequency pattern. One such modulation sequence has a number of elements, L, which number of elements L is equal to the number of REs occupied by the PRS in one OFDM symbol. This has the advantage that the favorable properties of the chosen modulation sequence, e.g. the PAPR and/or auto-correlation and/or cross-correlation properties, of the chosen modulation sequence, are preserved in the PRSs being generated.

Thus, the modulation sequences used for generating PRSs can be chosen such that they at least control the peak-to-average power ratio, provide good auto-correlation properties, and provide good cross-correlation properties. These characteristics of the modulation sequences are, according to the application, preserved in the generated PRS.

Because of this, the number of PRSs can be increased to be the same number as the number of cell IDs, while not sacrificing the performance, which is very advantageous, since the most efficient way to avoid network planning is to make the number of PRSs equal to the number of cell IDs. It is generally most straightforward regarding system complexity to have PRS which are unique and relate to the cell ID by a one-to-one mapping.

Thus, the embodiments can be used for increasing the number of PRSs to be the same as the number of cell IDs, while not sacrificing the performance. For instance, in LTE system (3GPP UTRA Rel.8), the number of cell IDs is 504. By utilizing the present application, 504 PRSs can easily be achieved.

According to one embodiment of the application, different modulation sequences are used in different PRSs to generate multiple PRSs from the same time-frequency pattern, in addition to controlling the peak-to-average power ratio.

According to different embodiments of the application, the modulation sequences are the same and different, respectively, in the different OFDM symbols within a PRS.

According to one embodiment of the application, the same modulation sequence is used in all OFDM symbols of the PRS.

According to different embodiments of the application, different PRSs have and have not, respectively, different modulation sequences.

According to a different embodiment of the application, the different modulation sequences are generated from one, or multiple, respectively, base modulation sequences through additional manipulation of the sequence elements.

According to an embodiment of the application, different cyclic shifts of one, or multiple, sequences are used in the different OFDM symbols within the PRS.

According to an embodiment of the application, cyclic shifts of two base modulation sequences of length L/2 are used in one OFDM symbol within the PRS.

According to an embodiment of the application, the two sequences of length L/2 are different and the two sequence shifts can be different.

According to different embodiments of the application, different phase modulation of one base modulation sequence and multiple base modulation sequences, respectively, are used in the different OFDM symbols within the PRS.

According to an embodiment of the application, the cyclic shifts and/or phase modulations can be determined implicitly by the receiving node based on, for example, cell identities and/or OFDM symbol numbers.

According to an embodiment of the application, the cyclic shifts and/or phase modulations in different OFDM symbols can be determined from the same integer sequence defining the time-frequency positions of REs in the PRS.

According to an embodiment of the application, the modulating sequences can be obtained from (one or several of) Zadoff-Chu sequences, QPSK sequences, Golay complementary sequences, and m-sequences.

Detailed exemplary embodiments and advantages of the generation and use of a PRS according to the application will now be described with reference to the appended drawings illustrating some preferred embodiments.

### BRIEF DESCRIPTION OF THE DRAWINGS

FIG. 1 shows a prior art subframe.

FIG. 2 shows a prior art PRS subframe.

FIG. 3 shows a prior art PRS subframe.

FIG. 4 shows mapping of REs to subcarriers.

FIG. 5 shows mapping of REs to Fourier coefficients of an N-point DFT.

FIG. 6 shows an example of mapping according to an embodiment of the application.

FIG. 7 shows an example of mapping according to an embodiment of the application.

FIGS. 8 and 9 show flow chart diagrams of the application.

FIGS. 10 and 11 show simulations of an embodiment of the application.

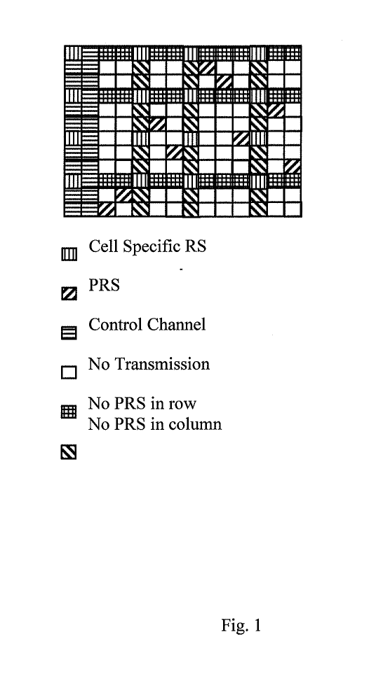

### DETAILED DESCRIPTION OF PREFERRED EMBODIMENTS

The application can e.g. be used in a multi-user OFDM-based transmission system for high-speed downlink shared channel in cellular systems, as well as other multi-carrier systems.

In some wireless communication systems, such as LTE, a reference signal defines a so called antenna port in a cell. Multiple orthogonal antenna ports can be used in a cell and they are transmitted on multiple physical transmit antennas.

In the following discussion, we consider one (1) antenna port to be used for positioning purposes. However, the claims is not limited to this and could be extended by a skilled person to multiple antenna ports for positioning.

According to the application, when generating a PRS, a time-frequency pattern of REs to be used for transmitting the PRS is determined. The time-frequency pattern normally occupies a number of OFDM symbols. Within each one of these OFDM symbols, the REs of the time-frequency pattern being within that OFDM symbol are assigned a value, which corresponds to an element in a modulation sequence. The modulation sequence has, according to the application, the same length, i.e. has the same number of elements as the number of REs belonging to the time-frequency pattern within that OFDM symbol. These values being assigned to the REs used for PRS in that OFDM symbol are then to be used for modulating OFDM subcarriers corresponding to those REs.

Thus, according to the application, when generating a PRS, a modulation sequence is applied to the REs used for the PRS. The same or different modulation sequences can be used in different PRSs, in addition to the same or different time-frequency patterns, to generate PRSs with low PAPRs and good auto-correlation and cross-correlation properties. In the following we describe more in detail how to generate modulation sequences and how to apply them to the OFDM symbols used for the PRS.

The problems being related to the peak-to-average power ratio (PAPR) of OFDM signals are well known for a skilled person. A large ratio implies that the power amplifier transmitting the signal has to be backed off to prevent non-linear distortion of the transmitted signal. This will lead to lower output transmit power being available, which results in reduced signal coverage. For positioning purposes this means that the hearability, i.e. the number of cells a receiving node, e.g. a UE, can detect, will be reduced. It will also limit the ability for the transmitter to use power boosting on the PRSs.

If the PRSs are left unmodulated, the result might become an undesirable co-phasing of the subcarriers at some instants, which creates unfavorable large signal power dynamics. Therefore, according to the application, the PRS should include a modulation being performed by the use of a modulation sequence, wherein the modulation is aimed at minimizing the peak-to-average power ratio.

There exists various types of sequences that have good signal dynamics properties, when being used as such a modulation sequence. For instance, in LTE, Zadoff-Chu sequences are widely utilized. Such a sequence can be defined as:

Zᵤ[k]=e^{-iπuk(k+1)/M},k=0,1, . . . ,M−1 (eq. 2)

where the index u should be relatively prime to the length of the sequence M. From equation 2, multiple sequences can be generated by using different indices u, which is referred to as different root sequences.

A sequence according to equation 2, which is defined in the frequency domain, has a unit magnitude and hence 0 dB peak-to-average power ratio. However, for OFDM, the sequence should modulate a set of subcarriers and PAPR should be studied in the time-domain. When excluding the DC subcarrier and being mapped to a set of non-consecutive subcarriers, the Discrete Fourier Transform (DFT) of the sequence does generally not become a Zadoff-Chu sequence. However, the resulting signal still typically exhibits good signal dynamics. Therefore, according to an embodiment of the application, the PAPR is reduced by assigning/mapping Zadoff-Chu sequences to the set of REs used for transmitting the PRS.

Zadoff-Chu sequences have favorable correlation properties. Also, Zadoff-Chu sequences can be manipulated, e.g. by being phase modulated, such that an orthogonal set of sequences is generated, where the resulting signals have low PAPR. This is utilized in an embodiment of the application. The constant magnitude of these sequences is also beneficial for channel estimation purposes.

According to other embodiments of the application, also other types of sequences, which are known to have good peak-to-average power properties, are used as modulation sequences. According to different embodiments, Golay complementary sequences, m-sequences, and QPSK sequences, respectively, are used for the modulation.

The modulation sequences used are defined in the frequency domain and are used to modulate the subcarriers that are utilized for PRS transmission. According to the application, if the number of REs used for PRS transmission within an OFDM symbol is L, the modulation sequence length should also be L. This has the effect that the favorable properties of the chosen modulation sequence, e.g. the PAPR properties of a Zadoff-Chu sequence, are preserved in the PRSs generated. Thus, by, in accordance with the application, not spreading the modulation sequence over more than one OFDM symbol, the generated PRSs will also get the advantageous properties of the modulation sequences chosen.

According to an embodiment of the application, to achieve that the number of REs used for PRS transmission within an OFDM symbol equals the length of the modulation sequence, the length of the modulation sequence should be adapted to that number of REs.

For example, for the case of Zadoff-Chu modulation sequences, this could be achieved by selecting the sequence length M in equation 2 such that it equals the number of REs used for PRS transmission within the OFDM symbol L, i.e. M=L.

Also, the sequence length M in equation 2 can be selected to be smaller than the number of REs used for PRS transmission within the OFDM symbol L, i.e. M<L, and then the modulation sequence can be (cyclically) extended from M to L elements.

Also, the sequence length M in equation 2 can be selected to be larger than the number of REs used for PRS transmission within the OFDM symbol L, i.e. M>L, and then the modulation sequence can be shortened from M to L elements.

As is clear to a skilled person, corresponding length adapting principles can also be applied to any other type of modulation sequence of length M.

Further, for generating the PRSs, multiple modulation sequences may be required. According to an embodiment of the application, this is achieved by starting from a base modulation sequence, and then this base modulation sequence is altered by a specific manipulation, whereby a modulation sequence to be used for modulation the PRS results from the manipulation. Thus, from each one of at least one base modulation sequences of length L, a number of different modulation sequences can be generated, as will be described below.

According to an embodiment of the application, the manipulation of the base modulation sequence involves making cyclic shifts of the base modulation sequence, so that each shift generates one unique modulation sequence. That is, for example, for a base modulation sequence Z[k] where k=0, 1, . . . , L−1, a cyclic shift of m steps is applied to generate a new modulation sequence according to

\tilde{Z}=Z[ mod(k−m,L)],k=0,1, . . . ,L−1. (eq. 3)

Due to the property of an N-point DFT, a cyclic shift of m subcarriers in the frequency domain results in a linear phase modulation in the time domain according to

X[ mod(k−m,N)] [symbol] e^{i2πmn/N}x[n], (eq. 4)

where X[k] is the modulation symbol of frequency k=0, 1, . . . , N−1 and x[n] is the signal sample at a time instant n=0, 1, . . . , N−1. The cyclic shift of the base modulation sequence in the frequency domain can therefore be equivalently implemented by a phase modulation (phase shift) of the base modulation sequence in the time-domain. The phase shift in the right hand side of equation 4 is denoted linear since the exponent is a linear function of n.

The phase shift (phase modulation) in equation 4 will not alter the peak power of the signal or the average signal power. Hence, if the cyclic shift is performed over all the N subcarriers of the DFT as equation 4 defines, then the peak-to-average power ratio does not change by this manipulation. Therefore, the advantageous PAPR properties of the base modulation sequence is preserved in the modulation sequence, which will be used for modulating the PRS.

Further, the PRS is transmitted on a set of REs, which are represented by time-frequency indices respectively and each RE should be mapped to the Radio Frequency (RF) domain and be transmitted on a subcarrier. One RE corresponds to one OFDM subcarrier during one OFDM symbol interval. For example in the LTE standard [Sec. 6.12, 5], the OFDM baseband signal is symmetrically mapped around an unmodulated DC subcarrier.

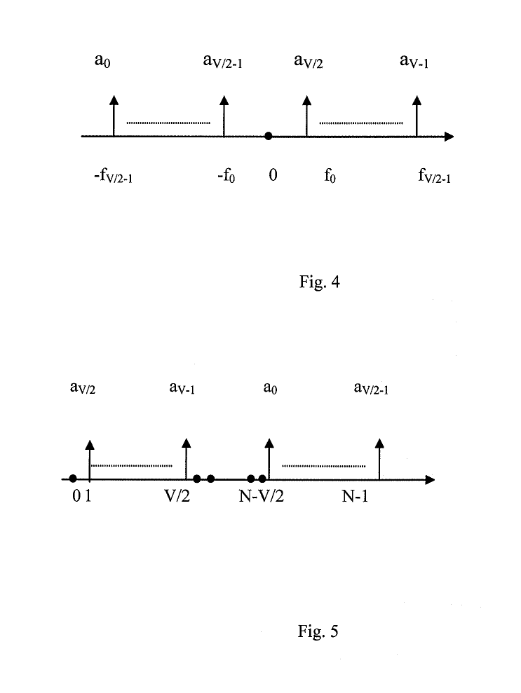

FIG. 4 illustrates the used principle for mapping a set of resource elements values {a₀, a₁, . . . , a_{V-1}} (V even) to the subcarrier frequencies in an OFDM symbol. The baseband generation of an OFDM signal is typically done by a DFT.

FIG. 5 shows the relation to the discrete domain assuming an N-point DFT is used, wherein the dots denote unmodulated frequencies. If a modulation sequence is mapped to the discrete frequencies according to FIG. 5, due to the unmodulated frequencies in the middle, the modulation sequence cannot be cyclically shifted modulo-N and the property of equation 4 cannot always be maintained. That is, the time-domain signal is not modulated by a linear phase term and the peak-to-average power may change.

However, according to an embodiment of the application, the manipulation of the at least one base modulation sequence includes performing a first and a second cyclic shift on a first and a second base modulation sequence of the same length, followed by a concatenation of these base manipulated modulation sequences.

According to an embodiment, the first and second cyclic shifts are different from each other.

Thus, by utilizing two base modulation sequences of length L/2 and performing the cyclic shifts on these two sequences separately, a signal with low PAPR can be generated.

According to an embodiment, the first and second base modulation sequences are obtained from different root modulation sequences, where a root sequence is a unique sequence not being a result of manipulation of another sequence. For example, two root sequences can be obtained from equation 2 from different indices u.

Hence, according to an embodiment of the application, cyclic shifts are made of two base modulation sequences Zᵤ[k] and Zᵥ[k] (u and v may be different, for which they become different root sequences), each being of length L/2, so that each shift generates one unique sequence according to:

$$\tilde{Z} [ k ] = \{ \begin{matrix}{Z}_{u} [ mod ( k - {m}_{u} , L / 2 ) ] , & k = 0 , 1 , … , L / 2 - 1 \\ {Z}_{v} [ mod ( k - {m}_{v} L / 2 ) ] , & k = L / 2 , … , L - 1.\end{matrix} \qquad ( eq . 5 )$$

This modulation sequence should be mapped in an N-point DFT, such that the first (or last) L/2 elements of equation 5 are mapped to frequencies 1, . . . , L/2 or N−L/2, . . . , N−1.

According to an embodiment of the application, different cyclic shifts of one base modulation sequence is used in the different OFDM symbols utilized for the PRS transmission.

According to another embodiment, different PRSs utilize different sets of cyclic shifts.

Further, according to an embodiment of the application, different phase modulations (phase shifts) are performed on the base modulation sequence or sequences, such that each phase modulation generates one unique modulation sequence. Due to the property of the N-point DFT, a linear phase shift in frequency domain results in a cyclic shift in the time domain according to:

x[ mod(n−m,N)] [symbol] e^{-i2πmk/N}X[k], (eq. 6)

where X[k] is the modulation symbol of frequency k=0, 1, . . . , N−1 and x[n] is the signal sample at time instant n=0, 1, . . . , N−1.

This embodiment can therefore also be equivalently implemented by a cyclic shift in the time-domain.

According to other embodiment of the application, these phase modulations of the base modulation sequence do not use the linear phase modulation shown in equation 6, but uses instead generally any general phase modulation method, linear and non-linear.

The cyclic shift in the time domain in equation 6 will not alter the peak (or average signal) power. Hence, if the phase modulation is performed over all the N subcarriers of the DFT as equation 6 defines, the peak-to-average power ratio does not change by this manipulation, which of course is advantageous.

According to an embodiment of the application, different phase modulations are used in the different OFDM symbols used for the PRS transmission. According to another embodiment, different PRSs utilize different sets of phase modulations.

Further, according to an embodiment of the application, the manipulation of the base modulation sequence is first performed, and then the values of the modulation sequence are assigned only to REs being part of the time-frequency pattern. Thus, this embodiment is similar to the phase modulation embodiment previously described, but only applies the phase modulation on the subcarriers that are used for transmitting the PRS.

That is, for a sequence Z[k] where k=0, 1, . . . , L−1 and L<N, a phase shift is applied according to:

\tilde{Z}[k]=e^{-i2πpk/L}Z[k],k=0,1, . . . , L−1. (eq. 7)

Due to the fact that the phase term cycles through one period, the sequence \tilde{Z}[k] in equation 7 is orthogonal to the sequence Z[k], if Z[k] has constant magnitude. Such orthogonality is beneficial if the TDOA determining method is implemented in the frequency domain.

Further, according to an embodiment of the application, the manipulation, i.e. the cyclic shift or the phase modulation is performed based on any one of a radio frame number, a PRS subframe number, an OFDM symbol number, a position of at least one RE in said time-frequency pattern, or a cell ID. By letting the manipulation depend on any one of these parameters, a receiving node, such as a UE, is able to detect the modulation sequence used without the need for signaling, since the receiving node already has knowledge of these parameters.

Further, according to an embodiment of the application, any general phase modulation method, i.e. not only the linear phase modulation shown in equation 7 can be used for performing this manipulation.

As is clear to a skilled person, also other manipulations than cyclic shifts and phase modulations of one, or several, base modulation sequences described above, can also be performed, as long as they preserve the PAPR and correlation features of the base modulation sequences.

Further, as has been stated above, the modulation sequence should modulate the REs in an OFDM symbol of a PRS subframe, where the REs are used for transmission of the PRS. The REs are typically represented by integer indices. According to an embodiment of the application, the sequence can be mapped to these REs by mapping the modulation sequence in increasing order of the REs. According to another embodiment, the modulation sequence is mapped in decreasing order of the REs. According to yet another embodiment, modulation sequences are mapped in any other pre-determined order.

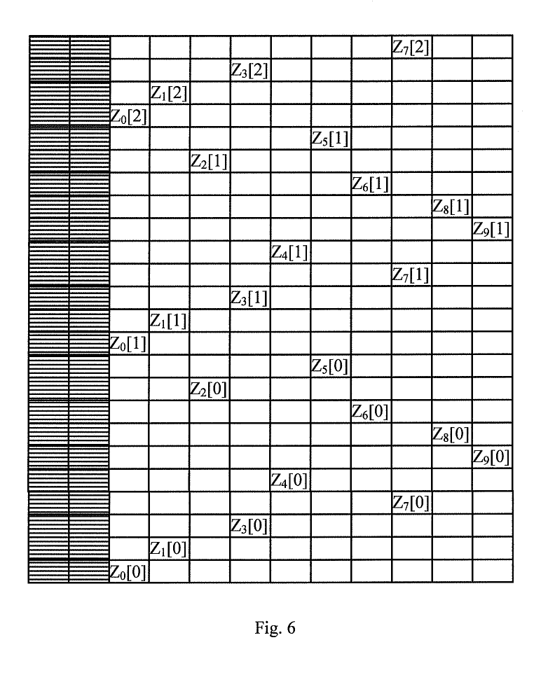

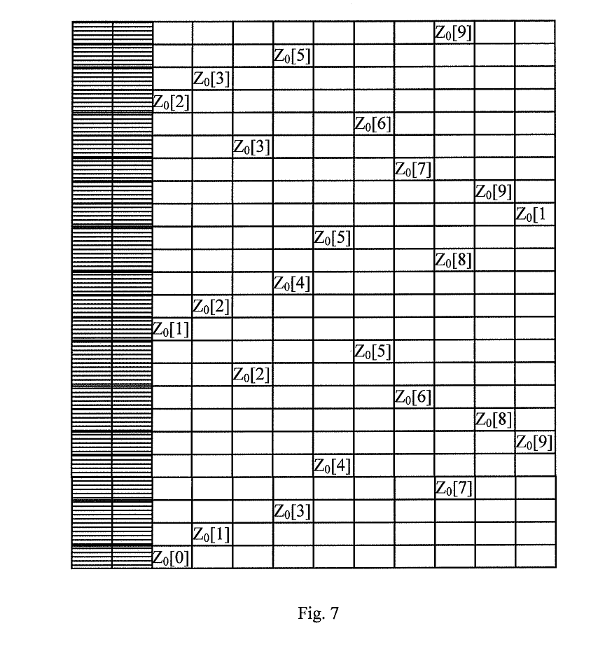

FIGS. 6 and 7 illustrate mapping of the modulation sequences to the REs of the PRS in an increasing order of the REs (lowest sequence index k to lowest RE).

FIG. 6 illustrates a mapping according to an embodiment of the application, in which different root modulation sequences Zᵤ[k] are mapped to the REs of a time-frequency pattern of a PRS. That is, different modulation sequences are used for different OFDM symbols.

FIG. 7 illustrates a mapping according to an embodiment of the application, in which one modulation sequence is mapped to all of the REs used for PRS, i.e. one modulation sequence is used for more than one OFDM symbol. Here, the base modulation sequence is cyclically shifted one step in every OFDM symbol.

Further, a number of alternatives exist for allocating the modulation sequences for transmission on to the REs in the PRS subframe.

According to an embodiment of the application, in a PRS subframe, a set of different modulation sequences is used in the different OFDM symbols. Such sets of multiple sequences can be obtained from different unique base modulation sequences, e.g. by using Zadoff-Chu sequences with different indices u.

According to an embodiment of the application, the manipulations, i.e. the cyclic shifts and/or the phase modulations of a single base modulation sequence are used to create the set of unique modulation sequences to be used in the different OFDM symbols and/or for the different PRSs. These manipulations are judiciously selected to reduce peak-to-average power ratios and improve correlation properties.

Also, according to an embodiment, different manipulations, i.e. the cyclic shifts and/or phase modulations, are used for the different PRSs, to generate multiple unique PRSs from a same time-frequency pattern.

Further, according to an embodiment, all PRSs use the same modulation sequences, which may or may not be the same in the different OFDM symbols within the PRS. This is the typical case where the main purpose of the modulation sequences is to achieve peak-to-average power reduction, but not to generate multiple PRSs from the same time-frequency pattern.

According to an embodiment of the application, the PRSs are transmitted in Resource Blocks (RBs), which belong to a subset of all the RBs in a subframe. Thus, the PRSs are not transmitted on all available RBs in the subframe. A RB is defined as the REs of time-frequency resources within 180 kHz×0.5 ms.

Further, a receiving node performs detection of a timing value to be used for determining its position. Generally, the receiving node, e.g. a UE, is aware of the cell IDs of a number of surrounding cells. The receiving node can then utilize its knowledge of at least three cells, for determining a time-frequency pattern of REs having been used for transmitting a received signal. Also, the receiving node is able to determine at least one modulation sequence having been used for modulating the OFDM subcarriers corresponding to REs of the time-frequency pattern. The at least one modulation sequence here has a length being equal to a number of the REs being within an OFDM symbol being part of the time-frequency pattern of the PRS. Based on the determined time-frequency pattern and the determined at least one modulation sequence, the receiving node can determine the timing value for the received signal in relation to signals from the other ones of the at least three cells.

Since the PRSs being generated have such great PAPR and correlation characteristics, the receiving node is able to determine the timing value more efficiently and accurately than in prior art systems. Also, system complexity being necessary for determining the timing value is minimized, since the number of PRSs can be made equal to the number of cell IDs in the system.

According to an embodiment of the application, the receiving node provides one or more determined values corresponding to a Time Difference of Arrival (TDOA) to its serving base station. The TDOA values are here determined based on the determined timing value.

According to another embodiment of the application, the receiving node itself utilizes the determined timing value for determining its position.

Since, according to an embodiment of the application, the manipulation of the base modulation sequence is performed based on any one of a radio frame number, a PRS subframe number, an OFDM symbol number, a position of at least one RE in said time-frequency pattern, or a cell ID, the receiving node can utilize this when determining at least one of the time-frequency pattern and the at least one modulation sequences. That is, the receiving node uses its knowledge of at least one of these parameters, and the known relationship between these parameters and the time-frequency patterns and/or the modulation sequences and/or the manipulations having been used in the transmitting node.

This has the advantage that the receiving node, e.g. a UE, is able to determine the PRS, i.e., both time-frequency pattern and modulation sequence (including any phase- or cyclic shifts) without any additional control signaling.

Thus, according to the application, the features characterizing the PRS are possible to be determined with the knowledge of the cell ID and possibly by additional other quantities known to the receiving node, such as a radio frame number, a PRS subframe number, an OFDM symbol number within a PRS subframe etc.

For example, cyclic shifts and phase modulations can be determined from the same integer sequence defining the time-frequency positions of REs in the PRS.

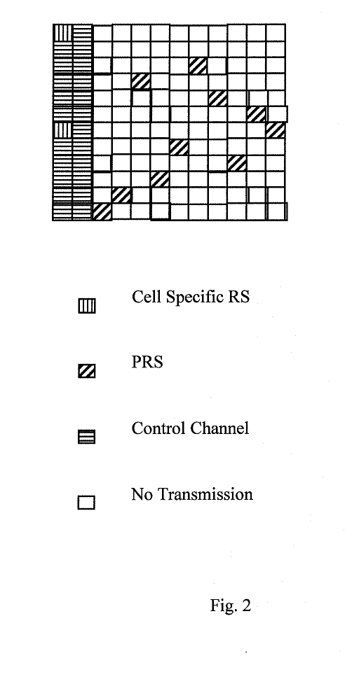

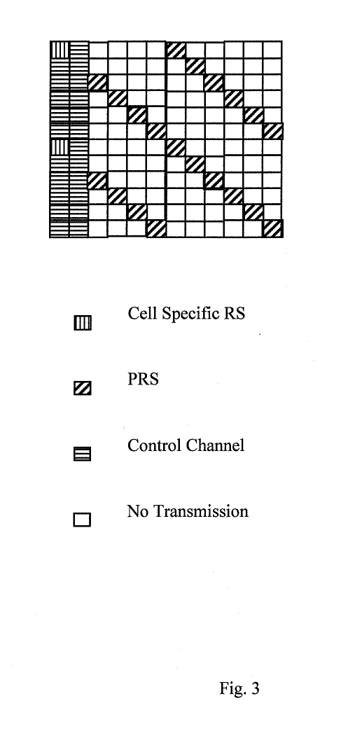

The following example illustrates an embodiment, for which the sequence shifts are determined from RE indices of the time-frequency pattern and the OFDM symbol number. The sequence shift in OFDM symbol nε{0, 1, . . . , 9} is here selected as m(n)=F(n)*(n+d) where F(n) denotes a RE frequency position in OFDM symbol n. For example, for the time-frequency pattern shown in FIG. 2, we use F(n)=[0, 1, 8, 2, 4, 9, 7, 3, 6, 5], and for the time-frequency pattern shown in FIG. 3 we use F(n)=[3, 2, 1, 0, 5, 4, 3, 2, 1, 0]. The first PRS could here use d=3, and the second PRS could use another value, e.g., d=4.

Further, the different steps described above can be combined or performed in any suitable order. A condition for this, of course, is that the requirements of a step, to be used in conjunction with another step of the method of the application, in terms of available parameters, must be fulfilled.

The method may be implemented by a computer program, having code means, which when run in a computer causes the computer to execute the steps of the method. The computer program is included in a computer readable medium of a computer program product. The computer readable medium may consist of essentially any memory, such as a ROM (Read-Only Memory), a PROM (Programmable Read-Only Memory), an EPROM (Erasable PROM), a Flash memory, an EEPROM (Electrically Erasable PROM), or a hard disk drive.

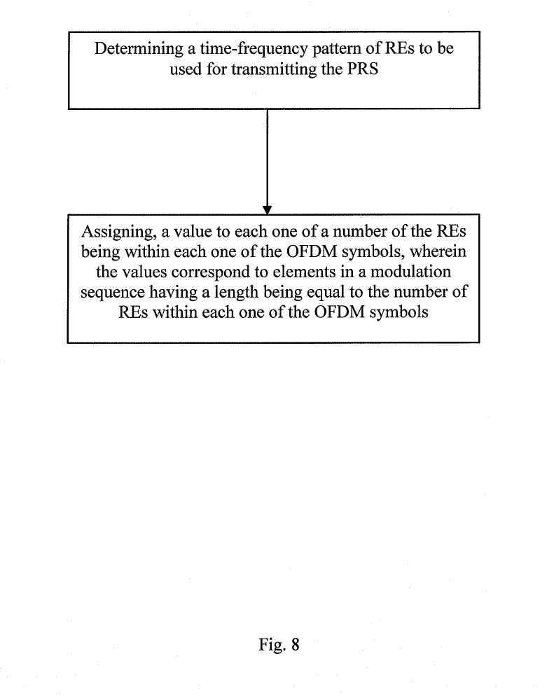

FIG. 8 shows a general flow chart diagram for the method of the application for generating a PRS according to the application. I the first step, a time-frequency pattern of REs to be used for transmitting the PRS is determined, wherein that time-frequency pattern includes at least two OFDM symbols. In the second step of the method, for each one of the at least two OFDM symbols, respectively, a value to each one of a number of the REs of the time—frequency patter, which are within that OFDM symbol, is assigned. The assigned values correspond to elements in a modulation sequence having a length being equal to the number of REs within that OFDM symbol.

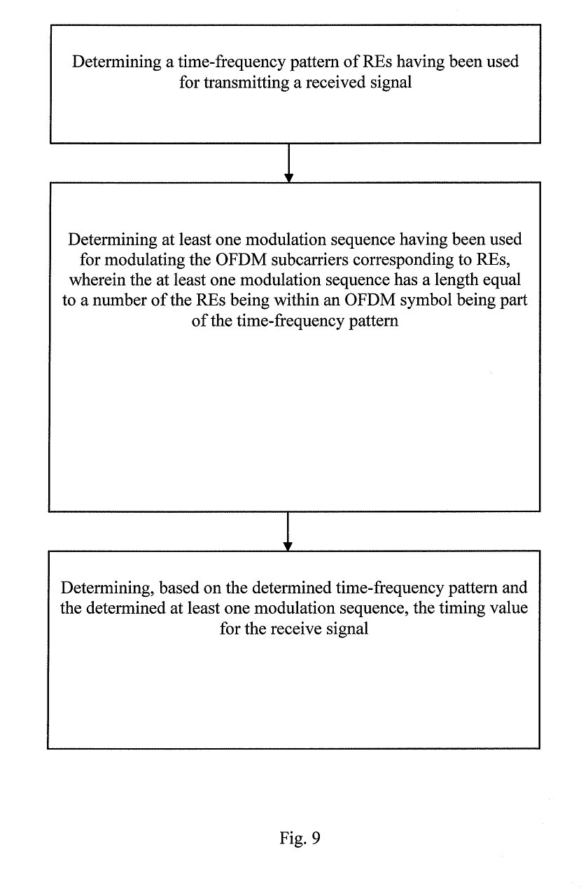

FIG. 9 shows a general flow chart diagram for the method of the application for detecting a timing value. In a first step of the method, a time-frequency pattern of REs having been used for transmitting a received signal is determined. In a second step of the method, at least one modulation sequence having been used for modulating the OFDM subcarriers corresponding to REs of the time-frequency pattern is determined. The length of the at least one modulation sequences is here equal to a number of the REs of the time-frequency pattern being within an OFDM symbol being part of said time-frequency pattern. In a third step of the method, the timing value is determined based on the determined time-frequency pattern and on the determined at least one modulation sequence.

Further, an entity arranged for generating a PRS according to the application, or a transmitting node generating the PRS itself, comprises determination means being arranged for determining a time-frequency pattern of Resource Elements (REs) to be used for transmitting the PRS, wherein that time-frequency pattern includes at least two OFDM symbols. The entity or transmitting node further comprises assigning means being arranged for assigning, for each one of the at least two OFDM symbols, respectively, a value to each one of a number of the REs being within that OFDM symbol. The values thereby being assigned to the number of REs of the time-frequency pattern correspond to elements in a modulation sequence having a length being equal to the number of REs used for PRS within that symbol. The values are to be used for modulating OFDM subcarriers corresponding to the REs within that OFDM symbol.

A receiving node according to the application, being arranged for detecting a timing value to be used for determining its position, comprises determining means being arranged for determining, while utilizing knowledge of a cell ID of each one of at least three cells, a time-frequency pattern of Resource Elements (REs) having been used for transmitting a received signal. The receiving node also comprises determination means being arranged for determining at least one modulation sequence having been used for modulating the OFDM subcarriers corresponding to the REs of the time-frequency pattern. The at least one modulation sequence here having a length being equal to a number of the REs being within an OFDM symbol being part of the time-frequency pattern. The receiving node also comprises determination means arranged for determining, based on the determined time-frequency pattern and the determined at least one modulation sequence, a timing value for the received signal in relation to signals from the other ones of the at least three cells.

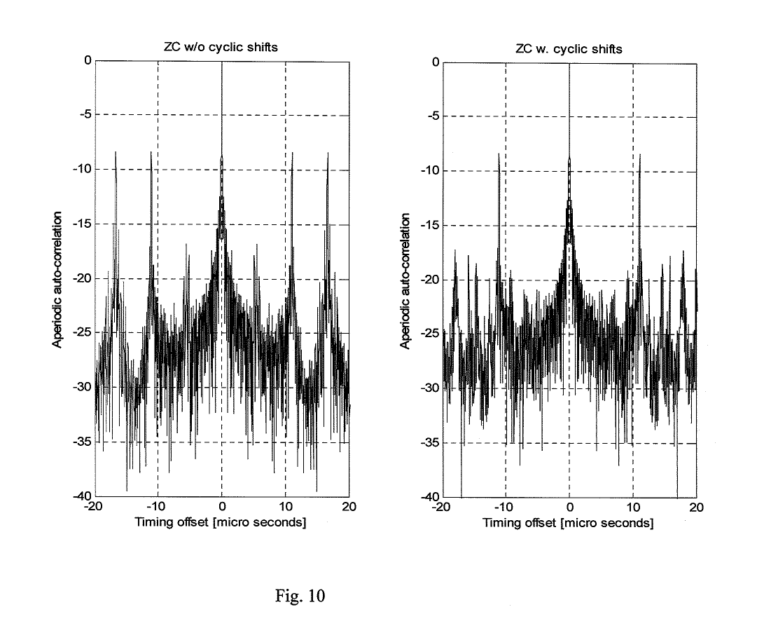

FIG. 10 shows a simulation of the aperiodic auto-correlation function for the time-frequency pattern shown in FIG. 3 over a 20 MHz channel. To the left, the same Zadoff-Chu modulation sequence is used in all OFDM symbols, while the plot to the right uses modulation sequences being generated by different cyclic shifts of the base modulation sequence for each OFDM symbol. It can be seen in FIG. 10 that the use of different modulation sequences, being generated by using cyclic shifts, produce lower sidelobes of the auto-correlation.

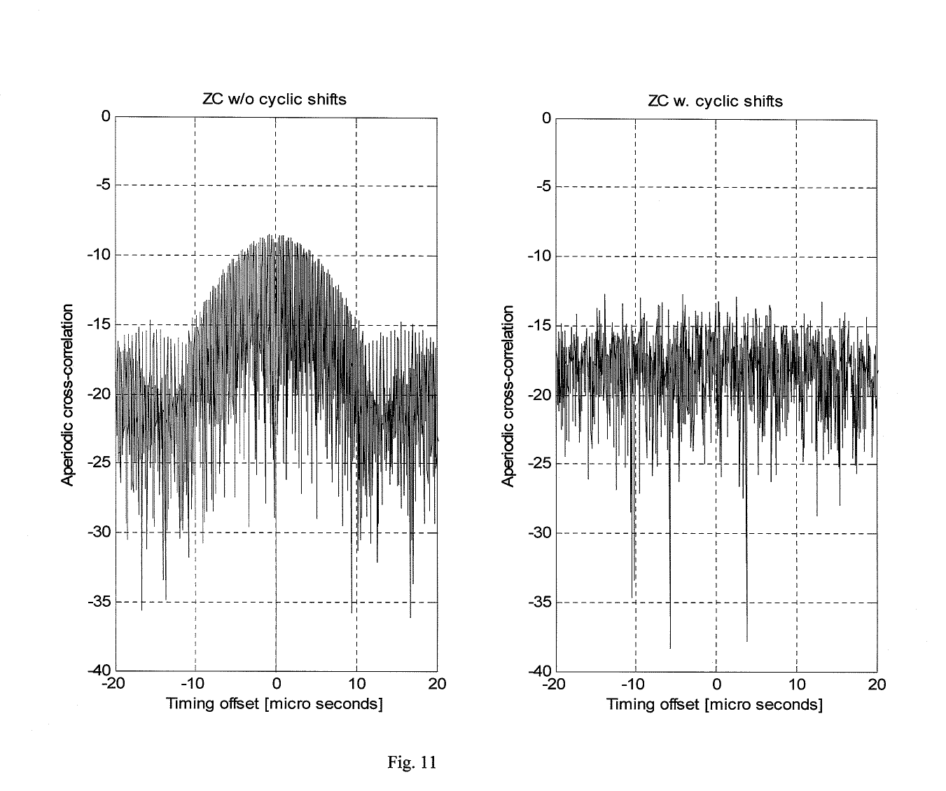

FIG. 11 shows a simulation of the aperiodic cross-correlation function for the same time-frequency pattern as simulated in FIG. 11. Also here, it can be seen that using different modulation sequences (the plot to the right) produce lower sidelobes also of the cross-correlation.

As is obvious for a skilled person, a number of other implementations, modifications, variations and/or additions can be made to the above described exemplary embodiments. It is to be understood all such other implementations, modifications, variations and/or additions which fall within the scope of the claims.

1. A method for generating a Positioning Reference Signal (PRS) to be used in a wireless Orthogonal Frequency Division Multiplexing (OFDM) communication system comprising:
determining a time-frequency pattern of Resource Elements (REs) to be used for transmitting said PRS, wherein said time-frequency pattern includes at least two OFDM symbols, and
assigning, for each one of said at least two OFDM symbols a value to each one of a number of REs being within that OFDM symbol, wherein
the values being assigned to said number of REs correspond to elements in a modulation sequence having a length being equal to said number of said REs, and the values are to be used for modulating OFDM subcarriers corresponding to said REs within that OFDM symbol.

2. Method as claimed in claim 1, wherein the modulation sequences being used for said at least two OFDM symbols has at least one of the characteristics in the group of:
at least one of said modulation sequences is the same as at least one second modulation sequence being used for at least one second PRS,
at least one of said modulation sequences is different from at least one second modulation sequence being used for at least one second PRS,
said modulation sequences are the same for said at least two OFDM symbols, and
said modulation sequences are different for each one of said at least two OFDM symbols.

3. Method as claimed in claim 1, wherein said time-frequency pattern has any of the characteristics in the group of:
said time-frequency pattern is the same as a second time-frequency pattern being used for at least one second PRS, and
said time-frequency pattern is different from a second time-frequency pattern being used for at least one second PRS.

4. The method as claimed in claim 1, wherein at least one of the modulation sequences being used for said at least two OFDM symbols is obtained while taking into consideration its influence on at least one of a parameter selected from the group of parameters consisting of:
a Peak-to-Average Power Ratio (PAPR),
an auto-correlation property, and
a cross-correlation property.

5. The method as claimed in claim 1, wherein at least one of the modulation sequences being used for said at least two OFDM symbols is obtained from a sequence selected from the group of sequences consisting of:
a Zadoff-Chu sequence,
a Golay complementary sequence,
a Quadrature Phase Shift Keying (QPSK) sequence, and
an m-sequence.

6. The method as claimed in claim 1, wherein at least one of the modulation sequences being used for said at least two OFDM symbols is obtained by performing a manipulation of at least one base modulation sequence, thereby resulting in that modulation sequence.

7. The method as claimed in claim 6, wherein said manipulation comprises:
performing a phase modulation in either a time domain or frequency domain of said base modulation sequence.

8. The method as claimed in claim 6, wherein said manipulation comprises:
performing a cyclic shift in a frequency domain or in a time domain on said base modulation sequence.

9. Method as claimed in claim 6, wherein said manipulation includes performing a first and a second cyclic shift on a first and a second base modulation sequence of equal length, respectively, and concatenating said first and said second cyclically shifted base modulation sequences.

10. The method as claimed in claim 1, comprising:
transmitting said PRS.

11. The method as claimed in claim 10, comprising:
transmitting said PRS in at least one Resource Block (RB) belonging to a subset of a total number of RBs in the system.

12. A method of a receiving node for detecting a timing value to be used for determining position of the timing value in a wireless Orthogonal Frequency Division Multiplexing (OFDM) communication system, wherein the receiving node utilizes knowledge of a cell ID of each one of at least three cells to detect the timing value, the method comprising:
determining a time-frequency pattern of Resource Elements (REs) having been used for transmitting a received signal,
determining at least one modulation sequence having been used for modulating the OFDM subcarriers corresponding to REs of said time-frequency pattern, wherein said at least one modulation sequence has a length being equal to a number of said REs being within an OFDM symbol being part of said time-frequency pattern, and
determining, based on said determined time-frequency pattern and said determined at least one modulation sequence, said timing value for said received signal in relation to signals from the other ones of said at least three cells.

13. The method as claimed in claim 12, wherein said the method further comprises:
providing at least one value corresponding to an Observed Time Difference of Arrival (OTDOA), being based on the determined timing value, to a serving base station, or
utilizing the determined timing value for determining its position.

14. The method as claimed in claim 12, wherein data utilized by said receiving node when determining at least one of the time-frequency pattern and the at least one modulation sequences includes at least one of:
a radio frame number,
a PRS subframe number, and
an OFDM symbol number.

15. The method as claimed in claim 12, wherein said receiving node determines at least one of a cyclic shift and a phase modulation, having been performed on at least one base modulation sequence when generating the at least one modulation sequences, by utilizing a position of at least one RE in said time-frequency pattern.

16. A non-transitory computer readable medium having stored thereon at least one code section for generating a Positioning Reference Signal (PRS) to be used in a wireless Orthogonal Frequency Division Multiplexing (OFDM) communication system, the at least one code section being executable by a machine to cause the machine to perform acts comprising:
determining a time-frequency pattern of Resource Elements (REs) to be used for transmitting said PRS, wherein said time-frequency pattern includes at least two OFDM symbols, and
assigning, for each one of said at least two OFDM symbols, respectively, a value to each one of a number of said REs being within that OFDM symbol, wherein
the values being assigned to said number of REs correspond to elements in a modulation sequence having a length being equal to said number of REs, and are to be used for modulating OFDM subcarriers corresponding to said REs within that OFDM symbol.

17. A computer program product comprising:
a processor; and
a non-transitory computer readable medium, wherein the computer readable medium has stored thereon at least one codes section executable by the processor to cause the processor to perform acts comprising:
determining a time-frequency pattern of Resource Elements (REs) to be used for transmitting said PRS, wherein said time-frequency pattern includes at least two OFDM symbols, and
assigning, for each one of said at least two OFDM symbols, respectively, a value to each one of a number of said REs being within that OFDM symbol, wherein
the values being assigned to said number of REs correspond to elements in a modulation sequence having a length being equal to said number of REs, and are to be used for modulating OFDM subcarriers corresponding to said REs within that OFDM symbol.

18. An entity arranged for generating a Positioning Reference Signal (PRS) to be used in a wireless Orthogonal Frequency Division Multiplexing (OFDM) communication system, comprising:
determination means arranged for determining a time-frequency pattern of Resource Elements (REs) to be used for transmitting said PRS, wherein said time-frequency pattern includes at least two OFDM symbols,
assigning means arranged for assigning, for each one of said at least two OFDM symbols, respectively, a value to each one of a number of said REs being within that OFDM symbol, wherein
the values being assigned to said number of REs correspond to elements in a modulation sequence having a length being equal to said number of REs, and are to be used for modulating OFDM subcarriers corresponding to the REs within that OFDM symbol.

19. A transmitting node arranged for transmitting a Positioning Reference Signal (PRS) in a wireless Orthogonal Frequency Division Multiplexing (OFDM) communication system, wherein said PRS has been generated by an entity comprising:
determination hardware configured to determine a time-frequency pattern of Resource Elements (REs) to be used for transmitting said PRS, wherein said time-frequency pattern includes at least two OFDM symbols,
assignment hardware configured to assign, for each one of said at least two OFDM symbols, respectively, a value to each one of a number of said REs being within that OFDM symbol, wherein
the values being assigned to said number of REs correspond to elements in a modulation sequence having a length being equal to said number of REs, and are to be used for modulating OFDM subcarriers corresponding to the REs within that OFDM symbol.

20. A receiving node arranged for detecting a timing value to be used for determining its position in a wireless Orthogonal Frequency Division Multiplexing (OFDM) communication system, comprising:
determination hardware configured to determine, while utilizing knowledge of a cell ID of each one of at least three cells, a time-frequency pattern of Resource Elements (REs) having been used for transmitting a received signal, at least one modulation sequence having been used for modulating the OFDM subcarriers corresponding to the REs of said time-frequency pattern, wherein said at least one modulation sequence has a length being equal to a number of said REs being within an OFDM symbol being part of said time-frequency pattern, and based on said determined time-frequency pattern and said determined at least one modulation sequence, said timing value for said received signal in relation to signals from the other ones of said at least three cells.
